(19) United States
(12) Patent Application Publication
(10) Pub. No.: US 2005/0114717 A1
(43) Pub. Date: May 26, 2005

(54) Operating method of a multimedia real-time system

(75) Inventor: Bai-Shiou Chen, Taipei (TW)

Correspondence Address: TROXELL LAW OFFICE PLLC, SUITE 1404, 5205 LEESBURG PIKE, FALLS CHURCH, VA, 22041, US

(73) Assignee: Infowize Technologies Corporation

(21) Appl. No.: 10/930,771

(22) Filed: Sep. 1, 2004

(30) Foreign Application Priority Data
Nov. 21, 2003 (TW) 92132802

(51) Int. Cl. G06F 1/26

(52) U.S. Cl. 713/300

(57) ABSTRACT

The present invention relates to a method for operating a multimedia real-time system, which involves the steps of turning on the power of the multimedia real-time system, starting the multimedia real-time system, and executing an operating interface of a multimedia real-time system. In the present invention, a real-time operating system starts to work as soon as the power of the multimedia real-time system is turned on, regardless of whether the multimedia real-time system is working. The real-time operating system is a master control, which enables the system to switch directly between the multimedia real-time system and the general visual Windows operating system, without any time delay.

### BACKGROUND OF THE INVENTION

1. Field of the Invention

The present invention relates to an operating method of a multimedia real-time system, more particularly to a method for operating a multimedia real-time system largely bases on a real-time operating system, which runs a real-time operating system before a multimedia real-time system or a general windows operating system is booted in the system.

2. Description of Prior Art

Seeing and hearing are the two most important perceptions for human beings; people obtain most information by seeing and hearing, and one can image how unromantic life without any sound or light would be. Splendid pictures created by an artist and wonderful music presented by a musician are all invaluable for human beings. Much painstaking work has been done for satisfying the aspirations for the video and audio. Thanks to development of technology, people can now enjoy much greater happiness brought by video and audio products than ever before; high-quality moving pictures, HI-FI music, HDTV program are very easily available now.

As a representative of modern technology, multimedia technology combines text, audio, video and data to provide vivid, effective, and impressive information in a way that interacts with the user, and plays an active role in many fields, such as entertainment, education, commercials, etc. The development of PCs (Personal computer) and the Internet further accelerate the popularity of multimedia.

Scientists and engineers are now working hard on helping people to gain access to multimedia via personal computers, more conveniently and more economically.

There are mainly two kinds of multimedia implementation employed in the product available on the market. The first one needs a special hardware device for each multimedia function. The second one implements multimedia functions with software applications running on a PC.

Referring to FIG. 1, which is a flowchart of a conventional multimedia operating system, operations thereof starts with step S100, turning the power on and starting the system. The second step S102 is to select a startup mode via a remote controller, which provides a controlling signal. The third step S104 is a decision of whether or not to enter a general visual Windows system. If the decision result is YES, then the system enters a general visual Windows system S106. The next step S108 is selection of a multimedia option with a remote controller. In next processing step S110, software application for the media option selected in step S108 is called and executed; the software application is specially designed for running on the conventional Windows operating system. A following decision step S112 decides whether or not to enters a multimedia operating system; if the answer is NO, then the system returns to step S108, and if the answer is YES, the system enters suspend mode and restarts in step S114.

If the answer to decision S104 is not to enter a general visual Windows system, then the system enters a multimedia operating system in step S116. Step S116 is followed by step S118, in which a multimedia option is selected, and a corresponding action of the multimedia option is executed in step S120. The next step S122 is to determine whether or not the system enters a general visual Windows operating system; if the answer is NO, then the system goes back to step S118. Otherwise, if the answer is YES, the system enters suspend mode and restarts S124, and goes to step S108.

The conventional multimedia operating system as described above has following characteristics:
1. There are at least two partitions on the hard disk; a general visual Windows operating system and a multimedia operating system are respectively installed in the two partitions, and two boot loader programs are also respectively installed into the two partitions for loading the needed operating system, according to user commands.
2. It takes at least 30 seconds to switch between the general visual Windows operating system and the multimedia real-time operating system, because the system must enter the suspend mode and restart.

FIG. 2A and FIG. 2B show a system flowchart of another conventional multimedia operating system, which comprises the steps of: turning on and startup the system S200, entering a multimedia operating system S202, deciding whether or not the system enters a general visual Windows operating system S204; if the answer is YES, then exiting the multimedia operating system and restarting the system S206, entering a multimedia operating system S208, and selecting a multimedia option with remote controller step S210. A software application is called and executed to implement the multimedia option S212; the software application can be closed and another software application for another multimedia option is called and executed in S214. The next step S216 is to detect whether a first suspend mode signal is generated; if the answer is YES, suspend mode is entered in S226. Step 228 further detects whether a second suspend mode signal is generated; if the answer is YES, then the system enters a general visual Windows operating system S208; otherwise, the system goes back to suspend mode of S226.

If the answer to the decision in step S216 is NO, following step S218 further detects whether there is a shutdown signal; if the answer to the decision S218 is NO, then the system maintains the present status S224. Conversely, if the answer to the decision S218 is YES, then system exits the general operating system S220, restarts and enters the multimedia operating system S222.

If the answer to the decision S204 is NO, a multimedia option is selected with a remote controller in step S230, and a software application for supporting the multimedia option is called and executed in step S232. The user can close the software application that is running and select another multimedia option in step S234. The system keeps detecting whether there is a shutdown signal S236. If the answer is NO, then the system maintains present status S242; otherwise, the system exits the multimedia operating system S238, and the system is restarted and enters a general visual Windows operating system S240.

The second conventional operating method of a multimedia system suffers from the following disadvantages:
1. The hard disk has to have at least two partitions, one for a multimedia operating system, which is a Linux operating system, the other for a general visual Windows operating system. The general visual Windows operating system is concretely a windows XP operating system.
2. The conventional prior art enters multimedia operating system by default during the multimedia system startup. The system must be restarted and re-selected to enter the general visual Windows operating system. It takes at least 40 seconds to finish the switch operation between the two operating systems.
3. The system cannot directly switch to the multimedia operating system in the general visual Windows operating system environment. A series of operation must be executed before successfully switching to multimedia operating system, which includes sending a shutdown command with remote controller, restarting system and selecting entrance into a general visual Windows operating system.

The two prior arts as described above have common disadvantages. It takes a long time to finish the switch operation between two operating systems, and the operating interface of the multimedia system must be purchased from a software company, thereby increasing the system cost.

Therefore, the present invention provides an improved operating method for multimedia real-time operating system that can overcome or at least reduce the disadvantages set forth above.

### SUMMARY OF THE INVENTION

Accordingly, an object of the present invention is to provide a method for operating a multimedia real-time system. The method uses a real-time operating system, which is burned into a hardware, and starts to work as soon as the power is turned on, regardless of whether the system is running.

Another object of the present invention is to provide a method for operating a multimedia real-time system, which can be applied to an IA (information appliance) to obtain information of the appliance.

To obtain the above objects, the present invention provides a method for operating a multimedia real-time system, which comprises the steps of: turning on the power of the multimedia real-time system; starting the multimedia real-time system; and executing an operating interface of a multimedia real-time system. In the present invention, a real-time operating system starts to work as soon as the power of the multimedia real-time system is turned on, regardless of whether the multimedia real-time system is working. The real-time operating system is a master control, which enables the system to switch directly between the multimedia real-time system and the general visual Windows operating system, without any time delay.

### BRIEF DESCRIPTION OF THE DRAWINGS

Other objects, advantages, and novel features of the present invention will become more apparent from the following detailed description when taken in conjunction with the accompanying drawings, in which:

FIG. 1 is a flowchart of a conventional multimedia operating system;

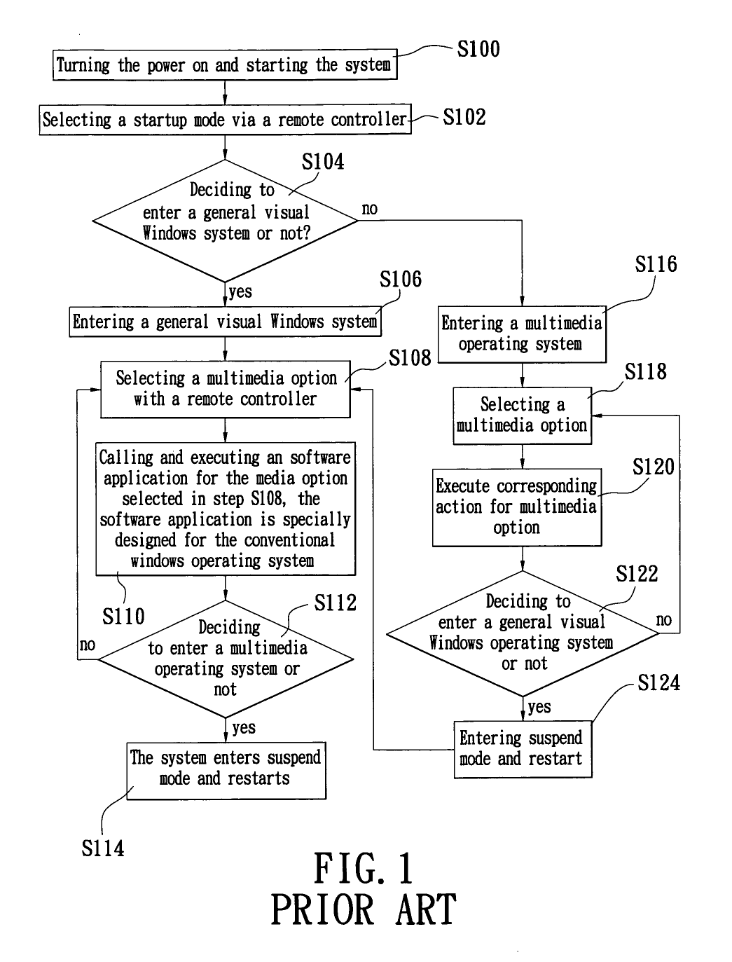

FIG. 2A is a main body of a flowchart of a second conventional multimedia operating system;

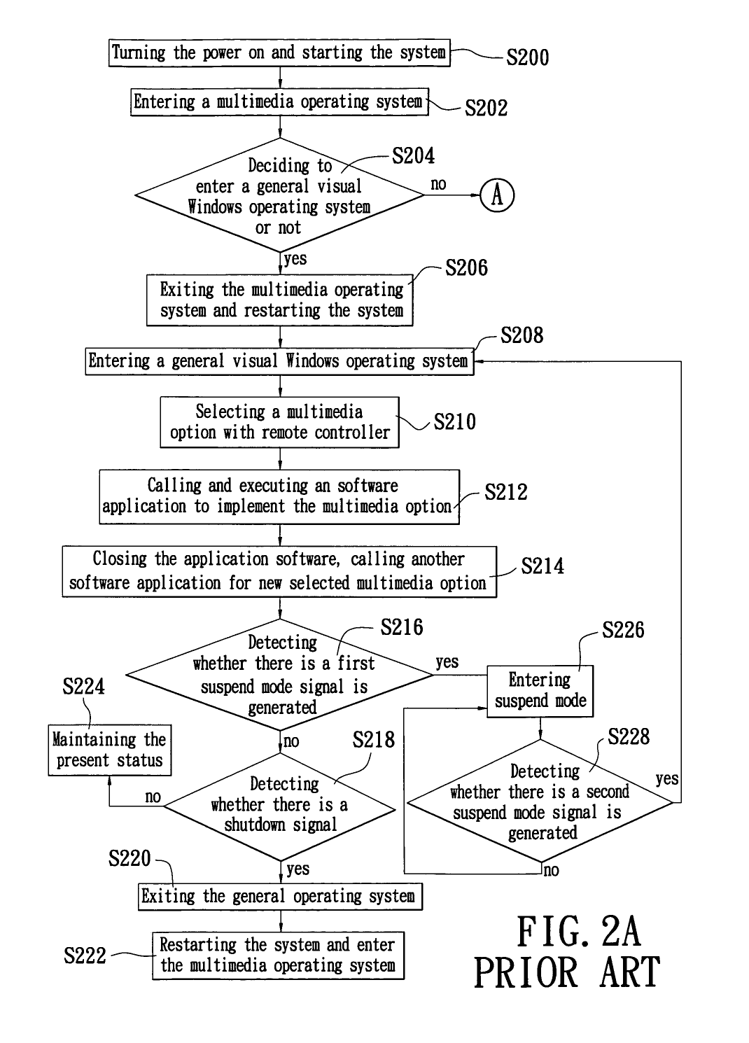

FIG. 2B is a branch of a flowchart of the second conventional multimedia operating system;

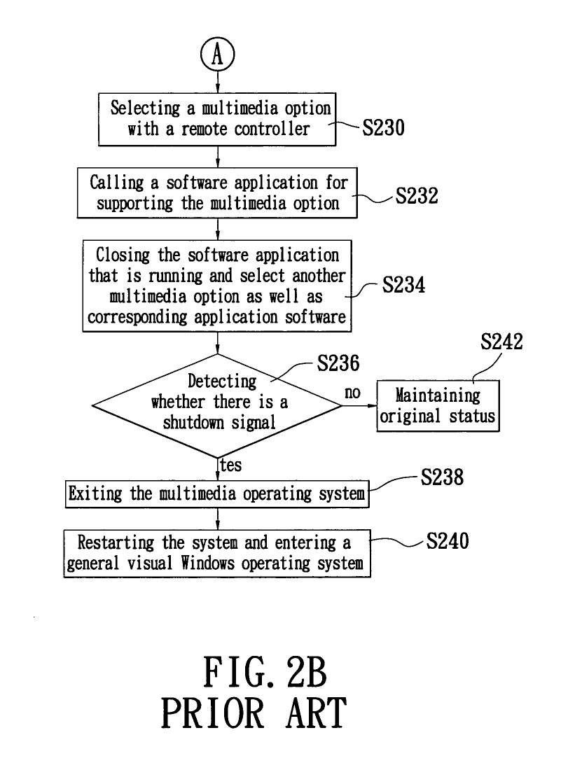

FIG. 3 is a flowchart of a multimedia real-time system of the present invention; and

FIG. 4 is a flowchart of an embodiment of the present invention.

### DETAILED DESCRIPTION OF THE INVENTION

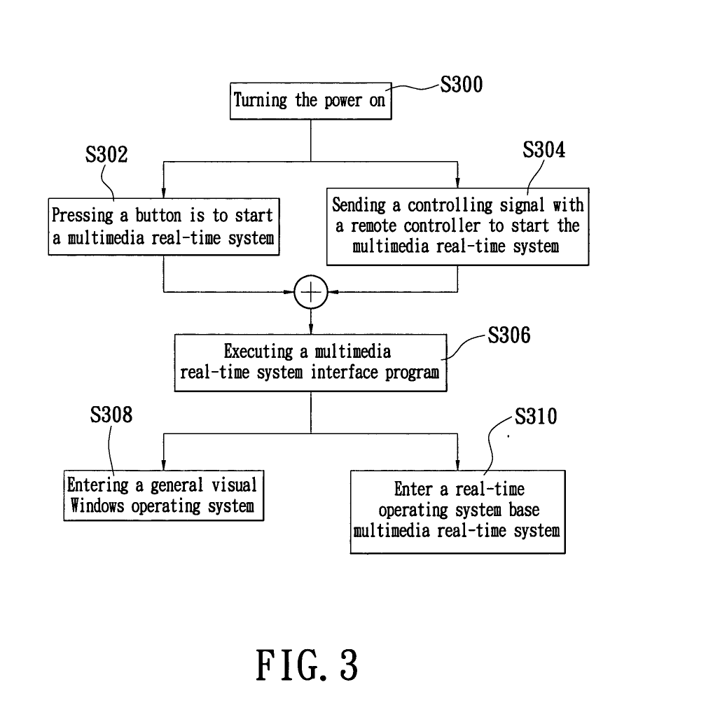

FIG. 3 is a flowchart of a multimedia real-time system of the present invention. The first step S300 is to turn on the power of the multimedia real-time system. In the next step S302, a button is pressed to start a multimedia real-time system; step S304 sending a startup command with a remote controller is another way to start the multimedia real-time system. In the next step, step S306, a multimedia real-time system interface program is run; from the multimedia real-time system interface, a user can select entrance into a real-time operating system base multimedia real-time system S310 or entrance into a general visual Windows operating system S308.

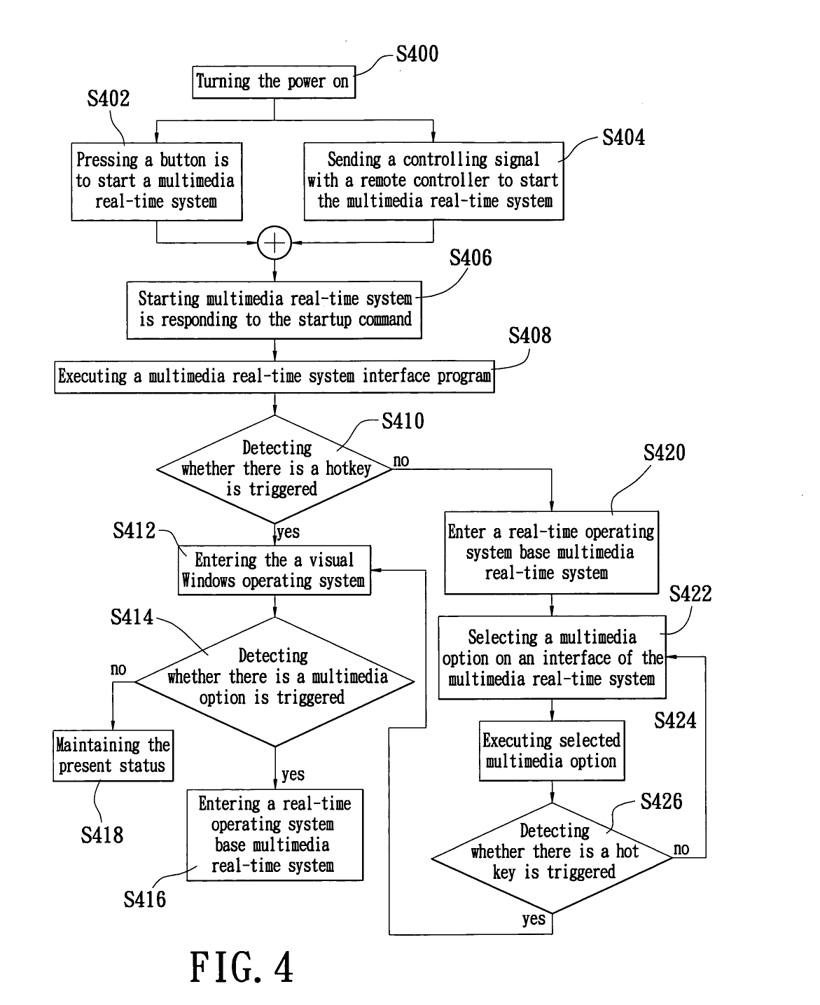

FIG. 4 is a system flowchart of an embodiment of the multimedia real-time system of the present invention. The first step S400 is to turn on the power of the multimedia real-time system. A button is pressed to start up a multimedia real-time system in step S402. Step S404, sending a startup command with a remote controller, is another way to start the multimedia real-time system. In step S406, the multimedia real-time system is started in response to the starting command. A multimedia real-time system interface program is executed and provides an operating interface in step S408. Decision S410 detects whether a hotkey is triggered; if the answer is YES, then the system enters a visual Windows operating system S412. Under the visual Windows operating system environment, the real-time operating system keep detecting whether a multimedia option is triggered (S414); if the answer is NO, the system maintains present status (S418). Otherwise, the system goes to a real-time operating system base multimedia real-time system (S416).

In decision S410, if the detection result is that no hot key is triggered, the system enters a real-time operating system base multimedia real-time system in step S420. The user can select a multimedia option for the operating interface in step S422, and a corresponding multimedia option is executed in the following step S424. Under the multimedia real-time system environment, the real-time operating system also keep detecting whether a hot-key is triggered (S426); if the hot-key is triggered, then the system enters a general visual Windows operating system S412. Otherwise, original status is maintained (S412), and the system stays in the multimedia real-time system.

The present invention has the following advantages:
1. The real-time operating system can be burned into a hardware.
2. The real-time operating system starts to run as soon as the power is turned on, but the multimedia real-time system may stay in waiting status and consume very little power until the real-time operating system is activated.
3. Stability of the multimedia real-time system is not subject to PC hardware fault or Windows operating system errors.
4. The real-time operating system is a master operating system, which controls the general Windows operating system.
5. With the help of the real-time operating system, the system can easily switch from the general operating system to the multimedia real-time system because of the real-time feature, and the switch operation therebetween takes almost no time.
6. The multimedia real-time system can provide the following multimedia options: a TV, a personal video recording (PVR), A DVD/VCD, A MP3 player, or an audio CD, a FM radio, a photo viewer.

Comparison of the features of the present invention and that of prior art are shown in the following table:

| | | The first | The second |
|---|---|---|---|
| | The present invention | prior art | prior art |
| BIOS Support | Any supplier | SI | SI |
| Mother Board | Any supplier | SI | SI |
| Support | | | |
| Compatibility | Good | Not very | Not very |
| | | good | good |
| Time consumption | Real time | About 30 sec | About 8 sec |
| and difficulty of | Does not have to | PC to | PC to Media |
| Switch between | restart | Media | Need not |
| different system | | Have to | restart |
| | | restart | |
| Capability of | Yes (2 sec) | NO | YES (8 sec) |
| switching to | | | |
| Suspend | | | |
| Mode & Time | | | |
| consumption | | | |
| Capability of | Yes (5 sec) | YES (30 sec) | NO |
| switching to sleep | | | |
| Mode & Time | | | |
| consumption | | | |
| Auto detecting | Auto restart | Hang | Hang |
| system action | | | |
| to fault | | | |

| | | |
|---|---|---|
| BUS Interface | USB2.0 interface | PCI interface |
| Software Operation | Free of resource | System stability subject to |
| Interface | conflict, capable of | resource conflict |
| | auto-detecting, | |
| | auto-repairing | |
| | High transmission data | Low transmission data rate, |
| | rate, excellent | relatively poor audio/video |
| | audio/video quality | quality |
| | Does not occupy PCI | Occupies PCI slots |
| | slot | (normally a semi-system |
| | Easy to install | has only one PCI slot), |
| | | limited expansibility |
| | Software can be | Authorization is required |
| | developed by the | for using software |
| | manufacture, | |
| | integrated | |
| | multimedia center | |
| Advantage in | User-friendly | Some interface is rather |
| operation | interface, a | complex, a remote |
| | single remote | controller is not enough for |
| | controller | some application programs |
| | can deal with | |
| | every operation | |

The invention has been explained in relation to one of its preferred embodiment. However, it is to be understood that many other possible modifications and variations can be made without departing from the spirit and scope of the invention as hereinafter claimed.

1. A method for operating a multimedia real-time system, comprising the steps of:
turning on a power of the multimedia real-time system;
starting the multimedia real-time system; and
executing an operating interface of a multimedia real-time system.

2. The method as claimed in claim 1, wherein after turning on the power of the multimedia real-time system, a real-time operating system starts to work before the multimedia real-time system startup.

3. The method as claimed in claim 1, wherein the step of starting the multimedia real-time system receives a key-pressed signal and informs a real-time operating system to start the multimedia real-time system.

4. The method as claimed in claim 3, wherein the key-pressed signal is synchronous with a controlling signal provided by a remote controller.

5. The method as claimed in claim 1, wherein the step of starting the multimedia real-time system receives a controlling signal provided by a remote controller and informs a real-time operating system to start the multimedia real-time system.

6. The method as claimed in claim 1, wherein the operation interface program runs on a real-time operating system.

7. The method as claimed in claim 1, wherein the step of executing further comprises a step of entering the multimedia real-time system largely based on a real-time operating system.

8. The method as claimed in claim 7, wherein the step of entering the multimedia real-time system also comprises entering a general visual operating system.

9. The method as claimed in claim 8, wherein the system directly switches between the multimedia real-time system and the general visual Windows operating system, without restarting the multimedia real-time system.

10. A method for operating a multimedia real-time system, comprising the steps of:
turning on a power of the multimedia real-time system;
starting the multimedia real-time system;
executing an operating interface of a multimedia real-time system; and
entering a general visual Windows operating system.

11. The method as claimed in claim 10, wherein after turning on the power of the multimedia real-time system, a real-time operating system starts to work before the multimedia real-time system startup.

12. The method as claimed in claim 10, wherein the step of starting the multimedia real-time system receives a key-pressed signal and informs a real-time operating system to start the multimedia real-time system.

13. The method as claimed in claim 12, wherein the key-pressed signal is synchronous with a controlling signal provided by a remote controller.

14. The method as claimed in claim 10, wherein the step of starting the multimedia real-time system receives a controlling signal provided by a remote controller and informs a real-time operating system to start the multimedia real-time system.

15. The method as claimed in claim 10, wherein the operation interface program runs on a real-time operating system.

16. The method as claimed in claim 10, wherein the multimedia real-time operating system keeps detecting whether a hot-key signal is triggered in the executing step.

17. The method as claimed in claim 16, wherein if a detection result is YES, the system enters a general visual Windows operating system, and if the detection result is NO, the system continues with the following steps:
entering a multimedia real-time system largely based on a real-time operating system;
selecting a multimedia option from the operating interface; and
executing jobs of the selected multimedia option.

18. The method as claimed in claim 17, wherein the multimedia option is a PVR (Personal Video Recorder).

19. The method as claimed in claim 17, wherein the multimedia option is a DVD/VCD player.

20. The method as claimed in claim 19, wherein the multimedia option is multi-functional DVD or VCD Player capable of read-writing and recording.

21. The method as claimed in claim 17, wherein the multimedia option is a sound effects player.

22. The method as claimed in claim 21, wherein the multimedia option is a sound effects player capable of playing .mp3 files or audio CDs.

23. The method as claimed in claim 21, wherein the multimedia option is a sound effect player capable of receiving and playing an FM broadcast program.

24. The method as claimed in claim 17, wherein the multimedia real-time operating system keeps detecting whether a hot-key signal is triggered in the executing step.

25. The method as claimed in claim 24, wherein if a detection result is YES, the system switches to a general Windows operating system, and if the detection result is no, the system returns to the step of selecting the multimedia option.

26. The method as claimed in claim 17, wherein the multimedia real-time operating system keeps detecting whether any multimedia option selecting signal is triggered in the executing step.

27. The method as claimed in claim 17, wherein if a detection result is YES, the system status directly switches to a multimedia real-time system largely based on a real-time operating system, and if the detection result is NO, the system maintains present status.
